(19) United States
(12) Patent Application Publication
(10) Pub. No.: US 2016/0144308 A1
(43) Pub. Date: May 26, 2016

(54) FILTER MEDIA AND METHODS OF MANUFACTURING THEREOF

(71) Applicants: Brent STOKES, Bethlehem, PA (US); FLSMIDTH A/S, Valby (DK)

(72) Inventor: Brent Stokes, The Woodlands, TX (US)

(21) Appl. No.: 14/898,975

(22) PCT Filed: Jun. 18, 2014
(86) PCT No.: PCT/US14/42841

§ 371 Date: Dec. 16, 2015

Related U.S. Application Data
(60) Provisional application No. 61/839,573, filed on Jun. 26, 2013.

(51) Int. Cl. B01D 39/16

(52) U.S. Cl. CPC B01D 39/163; B01D 39/1661

(57) ABSTRACT

Filtration media includes a layer of nonwoven fibrous material [10, 110], a layer of sintered porous material [30], and a web of bonding material [20] between the layer of nonwoven fibrous material [10, 110] and the layer of sintered porous material [30]. The nonwoven fibrous material [10, 110] is preferably attached to the web of bonding material [20] to form a first laminate [60, 160], and the sintered porous material [30] is attached to the web of bonding material [20] of the first laminate [60, 160]. The filter media [70, 170] is configured to withstand harsh industrial vacuum filtration environments, resist delamination, and be used on large industrial vacuum filters. A method of manufacturing a filter media is also disclosed.

### CROSS-REFERENCE TO RELATED APPLICATIONS

This application is a PCT application which claims priority to U.S. Provisional Patent Application No. 61/839,573, which was filed on 26 Jun. 2013.

### FIELD OF INVENTION

This invention relates to a filter media for a filtration apparatus and a method of manufacturing filter media. In one embodiment, a laminated filtration media for extracting liquids from a wet slurry fluid and for producing a substantially dry filter cake of the solid materials in the slurry is provided. The filter media may utilize supported or non-supported nonwoven fibrous material having a web of bonding material applied to it. The nonwoven fibrous material may comprise a felt comprised of single or multi-component fiber, such as a bi- or tri-component fiber. A sheet of sintered porous material, such as a polymeric sheet which is made up of one or more sintered polymeric particles, is applied to the web of bonding material to join the nonwoven fibrous material and the sheet of sintered porous material together to form a filter media product.

### BACKGROUND OF THE INVENTION

Slurry, which typically contains solid particulates suspended in a liquid, is often produced in many industrial processes. Often, it becomes necessary to separate the solids within the slurry from the liquid within the slurry so that each material may be treated in ways that will make disposal or use of the treated materials both economical and environmentally effective. In most such processes or systems, the slurry material is fed to a filter apparatus which may take many forms including, but not limited to, a belt press filter, a pressure filter (e.g., pneumatic filter, Nutsche filter, plate filter press, leaf filter, candle filter, PNEUMAPRESS® automatic pressure filter, etc.), or a vacuum filter (e.g., a vacuum belt filter, table filter, pan filter, tray filter, drum filter, pre-coat filter, disk filter, etc.). In one form of the latter (i.e., vacuum filtration system), a large drum filter comprising a drum covered with a filter media may provided which, by virtue of internal vacuum forces, forms a cake on outer portions of the drum while it rotates in a bath of slurry. The filter media covering the drum blocks the solids of the slurry from moving to the internal portions of the drum, and separates the liquid from the solids by letting liquid fractions of the slurry pass to inner portions of the drum. The filter media may be pre-coated to avoid wear and blinding of the filter media; however, this pre-coat generally restricts flow of filtrate, dewatering rate, and cake throughput. Liquids pass from the slurry and through the pre-coat and filter media and into an internal portion of the drum, leaving behind the solids fraction of the slurry accumulated on outer portions of the filter media/pre-coat. After a sufficient amount of slurry has been treated to accumulate solid materials, and a sufficient amount of liquid is removed from the sufficient amount of slurry, a cake is formed. Dewatered solids are removed by removing the cake from the filter media/pre-coat with a blade or equivalent means for further processing/harvesting the cake. The filter media is typically replaced periodically due to wear or “blinding” caused by clogging of the woven filter media with fines, and therefore, the filtration process can be repeated with a new clean filter media. The liquid (filtrate) and solids (cake) are separately used, treated or disposed of in an acceptable manner.

Pressurized gas and vacuum filtration are also used to extract the fluids from the slurry materials via filter media. Other technologies used in filter apparatuses have employed elastomeric diaphragms within a chamber, wherein the diaphragms are hydraulically (or pneumatically) actuated to create pressure differentials which squeeze out liquids from solid-containing slurry. Such systems may use compressed air (sometimes called “air-fluff”) following a hydraulic diaphragm squeeze to drive out interstitial liquid. These diaphragm and air squeeze systems generally add time to the filtration cycles resulting in lower production rates.

Examples of filter media that may be used in different filtration systems, slurry filtration systems, or filtration systems for separating solid particulates suspended within a fluid may be appreciated from U.S. Patent Application Publication No. 2007/0256984, U.S. Pat. Nos. 2,839,158, 3,044,957, 4,111,815, 4,130,487, 5,318,831, 6,110,249, 6,648,147, and 6,663,684, German Patent No. DE 3628187C, Chinese Patent Publication Nos. 202179905U and 1943840A, and Indian Patent No. 211488B. Often, filter media consists of a material that is covered with a laminate to help improve the filtration capacity of the base material. For instance, U.S. Pat. No. 6,663,684 discloses use of a polyphenylene sulfide web for adhering to a base filter cloth for a dust collecting filter cloth. Such filter media, however, may need replaced relatively quickly as the laminate is worn or degraded. Once the laminate surfaces are worn, the media may be much less effective at filtering a fluid having solids contained therein. In other instances, the laminate can shear off of the base filter cloth (i.e., “delamination”) rendering the filter media ineffective. U.S. Pat. No. 6,409,787 suggests a filter element comprised of two different materials each having different activation temperatures. However, such types of filter media are unable to withstand heavy industrial use without delaminating. U.S. Pat. No. 8,141,717 suggests compositions used in the manufacture of pen and ink applicators (e.g., marker tips), and small molded pipette filters. Moreover, U.S. Pat. Nos. 6,030,558; 6,399,188; 7,674,517; 7,795,346; 7,833,615; 7,985,343; 8,187,534; and 8,349,400 and U.S. Patent Application Publication Nos. 2003/0029789, 2004/0238440; 2008/0017569, 2009/0136705, 2010/0176210, 2012/0318139 show various porous polymeric compositions, which, alone would not be useable as a filter media on high capacity industrial filter equipment such as a drum filter and the like. U.S. Pat. No. 5,318,831 Col. 1 lines 48-53 indicates past treatment of filter cloth with silicone has produced poor results. U.S. Pat. No. 2,839,158 page 3 lines 5-10 suggests the application of silicone liquid having a viscosity greater than 20 centistrokes at room temperature, wherein the silicone liquid does not cure during use of the felt as a filter medium. The uncured silicone serves to capture fine particulates in dust filtration applications. U.S. Pat. No. 6,663,684 (page 2 lines 25-29) suggests a needle-punched felt which is coated with a silicone resin or fluororesin in order to have increased lubricity for dust removal from it. Publication CN202179905U suggests applying polytetrafluoroethylene (PTFE), hydroxy silicone, or a graphite emulsion “coating” under high temperature to form a filter media. CN1943840A suggests “dip coating processing” of a felt, wherein a filter media is prepared by adding water in a PTFE-dispersed liquid Teflon and silicone oil emulsion and dipping the felt therein. IN211488B suggests impregnating a “no-cure resin” comprising a methyl methacrylate, isobutyl methacrylate, and starches into a filter media comprised of blended hardwood and softwood fibers. U.S. Pat. No. 6,648147 suggests the application of a “layer” of fluoropolymer to the outer face of coagulated polymer. DE3628187C discusses a three-dimensionalized crosslinked silicone elastomer layer. U.S. Pat. No. 4,130,487 suggests a pleated cylindrical sheet of non-woven micro-porous glass fiber filter material which is impregnated with a binder. The binder may be silicone, polyurethane, phenolic resin, or epoxy resin, and the impregnated glass fiber filter material impregnated with the binder is then mounted in contact with expanded metal. U.S. Pat. No. 4,111,815 suggests a filter element for liquid comprising a layer of mineral wool and an apertured sheet, wherein a synthetic resin such as silicone or polyurethane is used to bond the two sheets together. U.S. Pat. No. 3,044,957 suggests inter-felted randomly oriented fibers which are formed into a sheet and made water repellant by impregnation with 15-30% by weight of phenol--formaldehyde or epoxy resin and 0.5-3% silicone resin. Silicone and polymer-coated yarns, surface-coated fluoropolymers, and filter media surface treatments are also known, but differ greatly from the invention.

In the starch, calcium carbonate, titanium dioxide, and magnesium hydroxide, and municipal wastewater management processes, upwards of 98% of production plants may rely on woven cloth filter media generally on the order of 1 mil thick. Such conventional woven filter media is easily damaged causing high solids content in the filtrate. When filtrate solids are exceeded, some plants (e.g., in the pigment industry) may be hit with large fines and penalties (e.g., sometimes upwards of $50,000 USD per day). Moreover, in many circumstances, blinding may hinder the efficiency of filtration in these processes leading to greater overhead, longer maintenance downtimes, and higher manufacturing costs. For instance, filtration rates of approximately 0.25-0.5 cubic feet per minute (CFM) of filtrate may be typical using conventional woven cloth filter. For this reason, some plants may require huge filtration circuits (e.g., upwards of 6-8 drum filters which can exceed 12 feet in diameter and 40 feet in length) in order to accommodate large throughputs and high production requirements needed to turn a profit.

Currently, to date, there are no other filter media fabricators, filtration equipment manufacturers, or filter fabricators which utilize sintered porous/micro porous sheets (e.g., formed from UHMWPE particles) as a component of a flexible filtration fabric which is configured to dress large-scale industrial production filters such as belt filters, disk filters, plate and frame filter presses, and drum filters. Accordingly, new and improved filter media and methods of manufacture thereof are needed.

### OBJECTS OF THE INVENTION

It is, therefore, an object of the invention to provide a filter media that is not susceptible to easy blinding or clogging, for example, in the starch, calcium carbonate, titanium dioxide, and magnesium hydroxide processes which are harsh on conventional woven filter cloths.

It is a further object of the invention to provide a filter media which is configured to maintain its structural integrity, stability, and durability within large-scale industrial vacuum and pressure filtration processes.

It is yet another object of the invention to provide a filter media that exhibits a reduced probability of delamination when mounting to an industrial filter, and which is less susceptible to abrasive slurry solids cutting into or pulling apart woven fibers.

It is another object of the invention to provide a filter media which will hold up to aggressive bends around rollers, and which is adapted to handle large localized changes in tension and friction.

A further object of the invention is to provide a filter media which can provide upwards of ten to twenty times the filtration rate over conventional filter media in certain filtration industries and processes.

Yet another object of the invention to provide a method of manufacturing a filter media which enhances the strength, durability, and filtration capacity of the filter media and base materials contained therein.

Other details, objects, and advantages of the invention will become apparent as the following description of certain present preferred embodiments thereof and certain present preferred methods of practicing the same proceeds.

### SUMMARY OF THE INVENTION

A method of making filter media for large industrial filtration devices is provided. The method comprises the steps of joining a layer of nonwoven fibrous material with a web of bonding material and joining a layer of sintered porous material to the web of bonding material. The step of joining the layer of nonwoven fibrous material with the web of bonding material may, in some instances, comprise a laminating step to form a first laminate. In certain embodiments, the step of joining the layer of sintered porous material to the web of bonding material may comprise laminating the first laminate with the layer of sintered porous material. The step of joining the layer of sintered porous material to the web of bonding material may occur after the step of joining the layer of nonwoven fibrous material with the web of bonding material.

In some preferred embodiments, the layer of sintered porous material comprises at least one polymer. The at least one polymer may comprise at least one of: polyethylene, polypropylene, polyester, polycarbonate, polyvinylidene fluoride, polytetrafluoroethylene, polyvinylidene fluoride, ethyl vinyl acetate, polycarbonate, polycarbonate alloy, Nylon 6, thermoplastic polyurethane (TPU), polyethersulfone (PES), and polyethylene-polypropylene copolymer without limitation. For example, the at least one polymer of the sintered porous material may comprise high-density polyethylene (HDPE) or ultra-high molecular weight polyethylene (UHMWPE). The layer of sintered porous material may be formed from particles of a first polymer and particles of a second polymer. The first polymer may be selected from the group consisting of: polyethylene, polypropylene, polyester, polycarbonate, polyvinylidene fluoride, polytetrafluoroethylene, polyethersulfone, polystyrene, polyether imide, polyetheretherketone, polysulfone, and/or combinations thereof. The second polymer may comprise a thermoplastic elastomer selected from the group consisting of: thermoplastic polyurethane, polyisobutylene, polybutene, polyethylene-propylene copolymer, polyethylene-butene copolymer, polyethylene-octene copolymer, polyethylene-hexene copolymer, chlorinated polyethylene, chloro-sulfonated polyethylene, styrene-ethylene-butadiene-styrene, multiblock copolymers having a polyurethane and either a polyester or polyether, 1,3-dienes, and/or combinations thereof. The layer of sintered porous material may comprise a reticulated structure having a mean porosity between approximately 20 and 80%. In some preferred embodiments, the layer of sintered porous material may comprise a rigidity according to ASTM 0747 of less than about 15 pounds. The nonwoven fibrous material may be unsupported or scrim-supported needled felt. Moreover, the nonwoven fibrous material may comprise bi-component fibers having a core and sheath of different polymeric materials, for instance, having a polypropylene core and a high density polyethylene sheath. The nonwoven fibrous material may further comprise multi-component fibers, wherein the multi-component fibers can be formed by at least two different polymeric materials selected from the group consisting of: polyethylene (PE), high density polyethylene (HDPE), ultra-high molecular weight polyethylene (UHMWPE), linear low density polyethylene (LLDPE), glycol-modified PET (PETG), polypropylene (PP), polylactic acid (PLA), polyphenylene sulfide (PPS), polyethylene terephthalate (polyester/PET), copolyester (CoPET), and/or combinations thereof. Multi-component polymeric fibers may be tri-component fibers without limitation. In some preferred embodiments, the web of bonding material may comprise a polymer such as polyamide, polyester, elastomeric, urethane, olefin polymer, and/or a composite thereof (for example, a sheer polyolefin sheet). The step of joining the nonwoven fibrous material with the web of bonding material may be performed using a fusing belt laminator.

The step of joining the nonwoven fibrous material with the web of bonding material may be performed at a rate between approximately 1 and 10 meters per minute, and more preferably at a rate of approximately 4.5 to 5.5 meters per minute (for example, about 4.9 meters per second). The step of joining the nonwoven fibrous material with the web of bonding material may comprise a height compression of between approximately 0.1 and 2.5 mm, and more preferably,

between approximately 0.9 and 1.5 mm, (for example, about 1.2 mm). The step of joining the nonwoven fibrous material with the web of bonding material may be performed at a temperature of between approximately 100 and 150 degrees Celsius, or more preferably between approximately 120 and 130 degrees Celsius on some, most, or all zones of lamination (e.g., about 125 degrees Celsius). The step of laminating the first laminate with the layer of sintered porous material may be performed at a rate between approximately 0.5 and 5 meters per minute, or more preferably at a rate of approximately 2.0-2.5 meters per minute. In some embodiments, the step of laminating the first laminate with the layer of sintered porous material may also be performed using a fusing belt laminator. The step of laminating the first laminate with the layer of sintered porous material may comprise a height compression of between approximately 0.1 and 5 mm, or more preferably, a height compression of between approximately 2.2 and 2.8 mm (for example, about 2.5 mm). The step of laminating the first laminate with the layer of sintered porous material may be performed at a temperature of between approximately 100 and 150 degrees Celsius on zones of lamination, or more preferably performed at a temperature of between approximately 120 and 130 degrees Celsius on some, most, or all zones of lamination (e.g. about 125 degrees Celsius).

Moreover, a filter media manufactured by the aforementioned method is also envisaged. Embodiments of the filter media may comprise a layer of nonwoven fibrous material, a layer of sintered porous material, and a web of bonding material between the layer of nonwoven fibrous material and the layer of sintered porous material. The nonwoven fibrous material may be bonded to the web of bonding material, and the layer of sintered porous material may also be bonded to the web of bonding material. The filter media may be configured to withstand harsh industrial vacuum filtration environments, resist delamination, and/or be used on large industrial filtration devices.

The layer of nonwoven fibrous material may comprise polymeric felt (which may be unsupported or scrim-supported), the layer of sintered porous material may comprise sintered polymeric particles, and the web of bonding material may comprise a sheer polymeric sheet. Polymeric particles used to form the sintered porous material 30 may comprise one or more of the following: polyethylene, polypropylene, polytetrafluoroethylene, polyvinylidene fluoride, ethyl vinyl acetate, polycarbonate, polycarbonate alloy, Nylon 6, thermoplastic polyurethane, polyethersulfone, polyethylene-polypropylene copolymer, and/or composites thereof. The sintered polymeric particles may comprise high-density polyethylene (HDPE) or ultra-high molecular weight polyethylene (UHMWPE). The polymeric felt may comprise homogeneous fibers, multi-component fibers (e.g., bi-component fibers having a core and sheath of similar or different polymeric materials o tri-component fibers), and/or combinations thereof. The bi-component fibers may comprise at least two different polymeric materials selected from the group consisting of: polyethylene (PE), high density polyethylene (HDPE), ultra-high molecular weight polyethylene (UHMWPE), linear low density polyethylene (LLDPE), glycol-modified PET (PETG), polypropylene (PP), polylactic acid (PLA), polyphenylene sulfide (PPS), polyethylene terephthalate (polyester/PET), copolyester (CoPET), and/or various combinations thereof.

The sheer polymeric sheet may comprise a polyamide, polyester, elastomeric, urethane, olefin polymer, and/or a composite thereof. In some instances, the sheer polymeric sheet may comprise an adhesive web of polyolefin fiber that weighs between approximately 0.25 and 0.75 ounces per square yard of material. In some embodiments, the layer of nonwoven fibrous material may be between approximately 10 and 150 mils thick, the layer of sintered porous material may be between approximately 0.5 and 25 mils thick, and the web of bonding material may be between approximately 10 and 150 mils thick. The overall thickness of the filter media may be between approximately 75 and 150 mils thick, and more particularly between approximately 95 and 130 mils thick, and even more particularly, between approximately 105 and 120 mils thick (for example, about 113 mils thick).

Other details, objects, and advantages of the invention will become apparent as the following description of certain present preferred embodiments thereof and certain present preferred methods of practicing the same proceeds.

### BRIEF DESCRIPTION OF THE DRAWINGS

To complement the description which is being made, and for the purpose of aiding to better understand the features of the invention, a set of drawings illustrating preferred filtration media and methods of making such filtration media is attached to the present specification as an integral part thereof, in which the following has been depicted with an illustrative and non-limiting character. It should be understood that like reference numbers used in the drawings may identify like components.

FIG. 1 is a schematic illustrating a first exemplary embodiment of a method of making a filter media.

FIGS. 2A and 2B are schematics illustrating first and second steps of a second exemplary embodiment of a method of making a filter media, respectively.

FIG. 3 is an enlarged fragmentary view of a sintered porous polymeric material used in the making filter media according to some embodiments.

FIG. 5 is an enlarged fragmentary view of bi-component fibers forming nonwoven material used in the making filter media according to some embodiments.

FIG. 6 illustrates a method of manufacturing a filter according to some embodiments.

FIG. 7 is a perspective view of a vacuum belt filter incorporating filter media according to some embodiments of the invention.

FIG. 8 is a cutaway view of a drum filter incorporating filter media according to the invention.

FIG. 9 is cutaway view of a disk filter incorporating filter media according to some embodiments of the invention.

FIG. 10 is side plan view of a “plate-and-frame”-type filter press incorporating filter media according to some embodiments of the invention.

FIG. 11 is a perspective view of a PNEUMAPRESS® automatic pressure filter incorporating filter media according to some embodiments of the invention.

FIGS. 12-16 show cross-sections of various multi-component fibers according to various embodiments.

FIGS. 17 and 18 show an exemplary method of manufacturing filter media using a fusing belt laminator.

In the following, the invention will be described in more detail with reference to drawings in conjunction with exemplary embodiments.

### DETAILED DESCRIPTION OF EXEMPLARY EMBODIMENTS

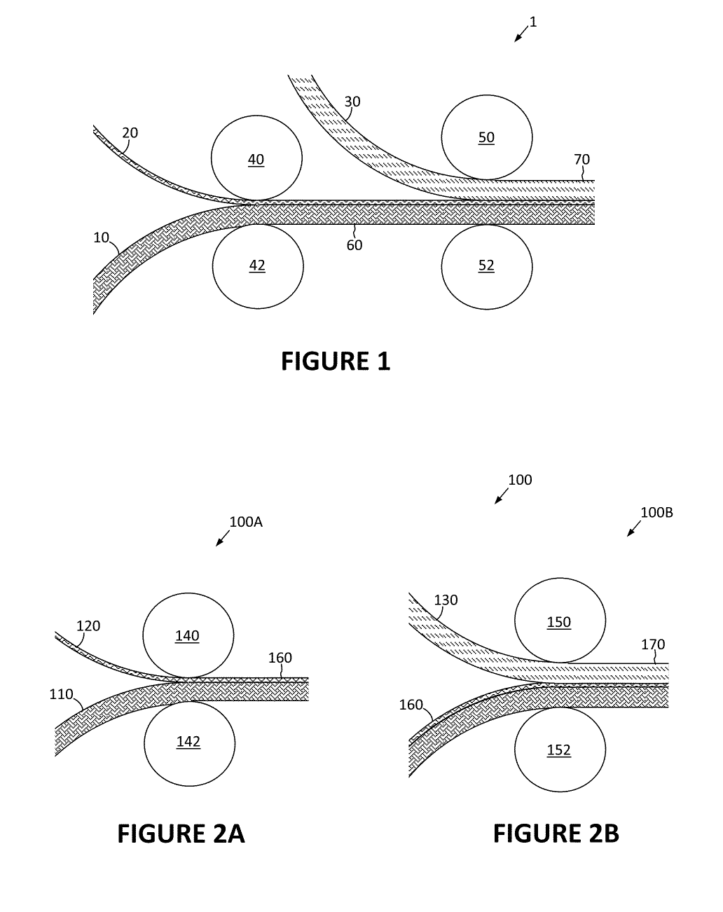

Referring to FIGS. 1-2B, filter media 70, 170 may be created for use in filtration operations involving one or more types of slurries, such as slurries that include a liquid and particulates such as ferrous and non-ferrous minerals, pigments, municipal wastewater sludge/solids, or food elements such as corn starch. It is contemplated that embodiments of the filter media 70, 170 may also be utilized to filter a gas such as air having solid particles entrained therein. It should be understood that the filter media may be used to physically block the solid particulates from passing therethrough to separate solid particulates from the fluid in which those particulates are entrained.

A filter media forming apparatus may be utilized to form the filter media 70. According to a first method 1, a filter media forming apparatus may include an upper first roller 40, a lower first roller 42, an upper second roller 50, and a lower second roller 52. A layer of nonwoven fibrous material 10 may be pre-attached to a web of bonding material 20 by passing the layer of nonwoven fibrous material 10 and the web of bonding material 20 between the upper first roller 40 and lower first roller 42. The resulting first laminate 60 may then be passed between the upper second roller 50 and lower second roller 52 with a layer of sintered porous material 30, wherein the layer of sintered porous material 30 may be joined to the first laminate 60 at a side facing the web of bonding material 20. The resulting filter media 70 may be removed and packaged (e.g., on a roll) for subsequent assembly and/or manufacture.

According to a second method 100 comprising a first step 100A and a second step 100B, Alternative filter media-forming apparatus may be utilized to form the filter media 170. During the first step 100A, a layer of nonwoven fibrous material 110 may be pre-attached to a web of bonding material 120 by passing the layer of nonwoven fibrous material 110 and the web of bonding material 120 between an upper first roller 140 and a lower first roller 142 of a first filter media forming apparatus. The resulting first laminate 160 may then be moved to a second filter media forming apparatus. During the second step 100B, the first laminate 160 may be passed between an upper second roller 150 and a lower second roller 152 with a layer of sintered porous material 130. The layer of sintered porous material 130 is preferably joined to the first laminate 160 at the side facing the web of bonding material 120. The resulting filter media 170 may be removed and packaged (e.g., on a roll) for subsequent assembly and/or manufacture. In some embodiments (not shown), second step 100B may re-utilize upper 140 and lower 142 rollers to join the first laminate 160 and the sintered porous layer 130 in lieu of upper 150 and lower 152 second rollers.

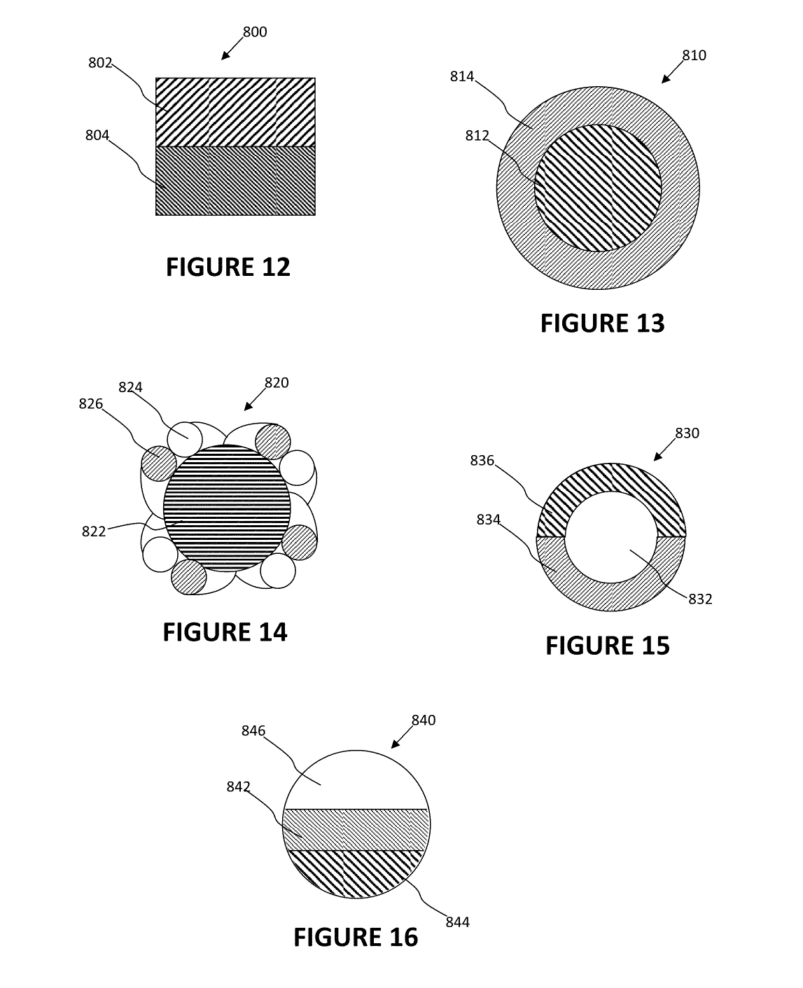

In some embodiments, the layer of nonwoven fibrous material 10 is preferably comprised scrim-supported or un-supported felt. The felt is preferably of the polymeric type which comprises one or more types of polymeric fibers. Fibers may include homogeneous monofilament, bi-component, or tri-component fibers. Bi- and tri-component fibers may comprise different materials. Multiple different types of monofilament fibers may also be incorporated into the nonwoven fibrous material 10. FIGS. 12-16, which will be described hereinafter, schematically illustrate cross-sectional views of some bi- and tri-component fibers which may be practiced with the invention, without limitation. In some embodiments, bi-component fibers 810 having a core 814 and sheath 812 structure are preferred for use in the felt used in the layer of nonwoven fibrous material 10. It should be understood that various mixtures of fiber types within the layer of nonwoven fibrous material 10 are anticipated by the inventor. For example, approximately 20-40% (e.g., 25%) of the layer of nonwoven fibrous material 10 may comprise bi-component fibers, whereas monofilament fibers may constitute the a remainder of the layer of nonwoven fibrous material 10. Relative proportions of bi-component fibers may change, but in preferred embodiments, a ratio of a first material to a second material in a bi-component fiber may be between approximately 15 and 85 percent (e.g., about 25%. Fibers used in the layer of nonwoven fibrous material 10 may comprise homopolymer acrylic, meta aramid, polyethylene (PE, HDPE, LDPE, UHMWPE), polyester (PET), polyimide (PI), polypropylene (PP), polyphenylene sulfide (PPS), polytetrafluoroethylene (PTFE), and or combinations thereof. In some embodiments, fibers used in the layer of nonwoven fibrous material 10 may comprise two of the aforementioned materials, e.g., high-density polyethylene (HDPE) and polypropylene. As shown in FIG. 5, nonwoven fibrous material 210 may comprise a series of similar bi-component fibers, each fiber having a core 216, a sheath 212, and a number of voids 214 therebetween.

In some embodiments, the adhesive web 20 is preferably comprised of a sheer sheet of randomly-arranged polymeric strands. The polymeric strands may be formed of a monomer or copolymer, and the sheer sheet of polymeric strands may comprise a single type of polymeric strands, or may comprise an assortment of different types of polymeric strands. Any one or more of the polymeric strands may comprise, without limitation, a polyamide fiber, a polyester fiber, an elastomeric fiber, a urethane fiber, an olefin polymer fiber, or a fiber comprising a combination of the aforementioned materials. In some more preferred instances, Spunfab® brand adhesive webs may be utilized. Other types of adhesive webs may be used, such as any one or more combinations of products disclosed in WO03064153, WO05097482, or WO06096170. As shown in FIG. 4, a web of bonding material 220 may comprise a number of strands 226 forming a sheer sheet. In some embodiments, an adhesive web of bonding material 220 may be provided in sheets which are nearly negligible in thickness (e.g., 0.1-1 mil thick), and weigh between 1 gram and 0.5 ounces per square yard of material.

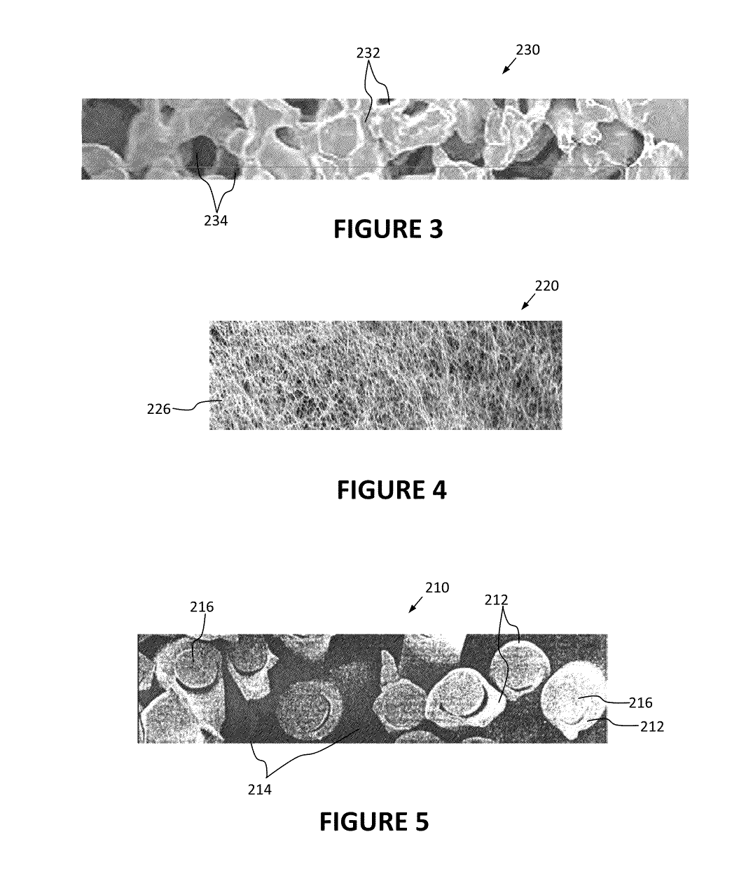

The layer of sintered porous material 30 may, in some preferred embodiments, be comprised of a plurality of particles which have been sintered together. As shown in FIG. 3, particles which have been sintered to form the layer of sintered porous material 30 may form a series of pores or voids 234 between fenestrations 232—thereby providing the layer of sintered porous material 30 with some amount of porosity and flexibility. The sintered particles may comprise any number of polymeric materials which demonstrate one or more advantageous chemical and mechanical properties such as resistance to wear, resistance to solvents, increased flexibility, and low friction coefficients). For example, the sintered particles may, in some instances, comprise a combination of one or more elastomers and one or more plastics (e.g., at least one plastic particle and a plurality of different elastomeric particles, or, a plurality of different types of plastic particles and at least one type of elastomeric particle).

In certain embodiments, elastomers may make up between about 10 and 90%/wt of the layer 30 of sintered porous material. For example, approximately 20-80%/wt, 30-70%/wt, or 40-60%/wt of the layer of sintered porous material 30 may comprise elastomeric particles. In some non-limiting embodiments, approximately 50%/wt of the layer of sintered porous material 30 may comprise elastomeric particles. Particles which are sintered to form the layer of sin porous material 30 may be um or randomized d in shape. Moreover, a size distribution of particles which are sintered may be uniform or randomized throughout portions of or the entire layer 30. In instances where a particle size distribution increases or decreases along a width of the layer of sintered porous material 30, a “functionally-graded” layer may be provided having gradient porosity functionality (e.g., a reduced porosity in area towards the web 20 and fibrous material 10, and an increased porosity in areas of the layer 30 further from the web 20 and fibrous material 10).

Particles which are sintered to form the layer of sintered porous material 30 may each comprise a single homogeneous material, multiple types of materials, or one or more composite materials. For instance, a sintered particle within the layer of porous material 30 may comprise one or more monomers, polymers, plastics, elastomers and/or combinations thereof in a predetermined ratio. The layer 30 may take any desired shape or form such as sheet or a film, or ma r be crafted from a block of sintered porous material which has been “sliced” into one or more thin sheets or films. In one particular embodiment, a layer of sintered porous material is fabricated thinly, so as to exhibit improved flexibility and be configured to be laminated and/or joined to a layer of nonwoven fibrous material 10 via an adhesive web 20. In some embodiments, the layer of sintered porous material 30 may be formed by fusing multiple layers of sintered porous material together.

Plastics, where used herein, may include flexible plastics and rigid plastics, without limitation, and may include polyolefins, polyamides, polyesters, rigid polyurethanes, polyacrylonitriles, polycarbonates, polyvinylchloride, polymethylmethacrylate, polyvinylidene fluoride, polytetrafluoroethylene, polyethersulfones, polystyrenes, polyether imides, polyetheretherketones, polysulfones, and combinations/copolymers thereof. In some preferred embodiments, a polyolefin plastic may be selected as a material used in the layer of sintered porous material 30. The polyolefin may comprise polyethylene, polypropylene, and/or copolymers thereof. In some embodiments, polyethylene may be utilized, which may comprise high density polyethylene (HDPE) having a density ranging from about 0.92 g/cm³to about 0.97 g/cm³ or a degree of crystallinity (% from density) ranging from about 50 to about 90. In other embodiments, polyethylene utilized in the layer of sintered porous material 30 may comprise ultrahigh molecular weight polyethylene (UHMWPE) having molecular weights greater than 1,000,000.

In addition to at least one plastic, some of the sintered polymeric materials provided within the layer of sintered porous material 30 may comprise at least one elastomer such as a thermoplastic elastomer (TPE) like polyurethane or thermoplastic polyurethane (TPU). Thermoplastic polyurethanes may include multi-block copolymers comprising polyester or polyether, and polyurethane. In other embodiments, elastomers used to form the layer of sintered porous material 30 may comprise, without limitation, polyisobutylene, polybutenes, butyl rubber, and/or combinations thereof. In further embodiments, elastomers may comprise copolymers of ethylene and other polymers such as polyethylene-propylene copolymer (EPM), ethylene-butene copolymer, polyethylene-octene copolymer, and polyethylene-hexene copolymer. In a further embodiment, elastomers may comprise chlorinated polyethylene or chloro-sulfonated polyethylene. In some embodiments, elastomers suitable for use in the layer of sintered porous material 30 of the preset invention may comprise 1,3-dienes and derivatives thereof. 1,3-dienes include styrene-1,3-butadiene (SBR), styrene-1,3-butadiene terpolymer with an unsaturated carboxylic acid (carboxylated SBR), acrylonitrile-1,3-butadiene (NBR or nitrile rubber), isobutylene-isoprene, cis-1,4-polyisoprene, 1,4-poly(1,3-butadiene), polychloroprene, and block copolymers of isoprene or 1,3-butadiene with styrene such as styrene-ethylene-butadiene-styrene (SEBS) may also be utilized. In other embodiments, elastomers may comprise polyalkene oxide polymers, acrylics, or polysiloxanes (silicon s), and/or combinations thereof. Examples of commercially-available elastomers suitable for use in the layer of sintered porous material 30 may comprise FORPRENE®, LAPRENE®, SKYPELOD, SKYTHANE®, SYNPRENE®, RIMFLEX®, Elexar, FLEXALLOY®, TEKRON®, DEXELEX®, Typlax, Uceflex, ENGAGE®, HERCUPRENE®, Hi-fax, Novalene, Kraton, Muti-Flex, EVOPRENE®, HYTREL®, NORDEL®, VITON®, Vector, SILASTIC®, Santoprene, Elasmax, Affinity, ATTANE®, and SARLINK®, without limitation.

Porosity in the layer of sintered porous material 30 may range from about 10% to about 90%. For example, in some embodiments, the layer of sintered porous material 30 may comprise at least one plastic and at least one elastomer and have a porosity ranging from about 20% to about 80% (e.g., between about 30% and about 70%). In further embodiments, a layer of sintered porous material 30 may comprise at least one plastic and at least one elastomer and have a porosity ranging between approximately 40% and 60% (e.g., 50% open space). In some preferred embodiments, the layer of sintered porous material may comprise micro porosities or regions of varying porosity throughout the layer. In some instances, the layer of sintered porous material 30 may comprise an average pore size ranging from about 1 μm to about 200 μm. For example, in some non limiting embodiments, pore size may be between about 2 μm and 150 μm, between about 5 μm and 100 μm, or between about 10 μm and 50 μm). In some embodiments, the layer 30 of sintered porous material may comprise an average pore size of less than about 1 μm (e.g., about 0.1-1 μm). In further embodiments, pore sizes may exceed 200 μm. In one particular non-limiting embodiment, sintered porous material comprising at least one plastic and at least one elastomer may have an average pore size ranging from about 200 μm to about 500 μm or from about 500 μm to about 1 mm.

The layer of sintered porous material 30 may have a density between approximately 0.1 g/cm³ and 1 g/cm³, and more particularly between approximately 0.2 g/cm³and 0.8 g/cm³. In some instances, density of the layer of sintered porous material 30 may fall between 0.4 and 0.6 g/cm³ (e.g., about 0.5 g/cm ³ m). In further embodiments, a layer of sintered porous material may comprise at least one plastic and at least one elastomer and may exhibit a density greater than about 1 g/cm³. In yet even further embodiments, the layer of sintered porous material 30 may have a density less than about 0.1 g/cm³. Sintered porous materials described herein may further comprise a rigidity according to ASTM D747 (i.e., “Standard Test Method for Apparent Bending Modulus of Plastics by Means of a Cantilever Beam”) of less that about 15 pounds, for example, less than about 10 pounds. In some embodiments, a rigidity of the layer of sintered porous material 30 may be less than about 5 pounds, for example, less than about 1 pound. Tensile strength of the layer of sintered porous material 30 may range from about 10 to about 5,000 psi as measured according to ASTM D638. For example, in some embodiments, the tensile strength may fall within the range of about 50 to 3000 psi or between 100 and 1,000 psi as measured according to ASTM D638. In some embodiments, a layer of sintered porous material 30 comprising at least one plastic particle sintered with at least one elastameric particle may have an elongation of 10% to 500%. In some embodiments, the layer of sintered porous material 30 may be provided in thicknesses less than ¼″, and above 1/16″, for example around 1/8″ or around 0.07 to 0.09 inches.

In use, filtration solids are stopped, held, or hindered b the layer of sintered porous material 30. Voids 234 within the sintered porous material 230 are configured to prevent migration of the filtration solids from penetrating through the layer 30, as well as prevent, slow, or hinder migration of filtration solids through subsequent layers (i.e., fibrous material 10 and/or bonding web 20). The rigidity and toughness of the layer of sintered porous material 30 further helps to prevent solids (which may get trapped in voids 234) from experiencing micro-motion and wear therefrom commonly seen with conventional woven cloth filter media. The web of bonding material 220 serves to prevent delamination of the layer of sintered porous material 30 from the layer of nonwoven fibrous material 10 as the filter media 70, 170 traverses sharp corners, small pulleys, and experiences high tensile and shear forces during filter operations and/or during fitment to a filtering apparatus. Sheaths 212 of hi-component fibers within the nonwoven fibrous material 10 may be chosen to be most compatible with the material of the web 220 and/or the sintered porous material 730 in order to further mitigate the risk of delamination.

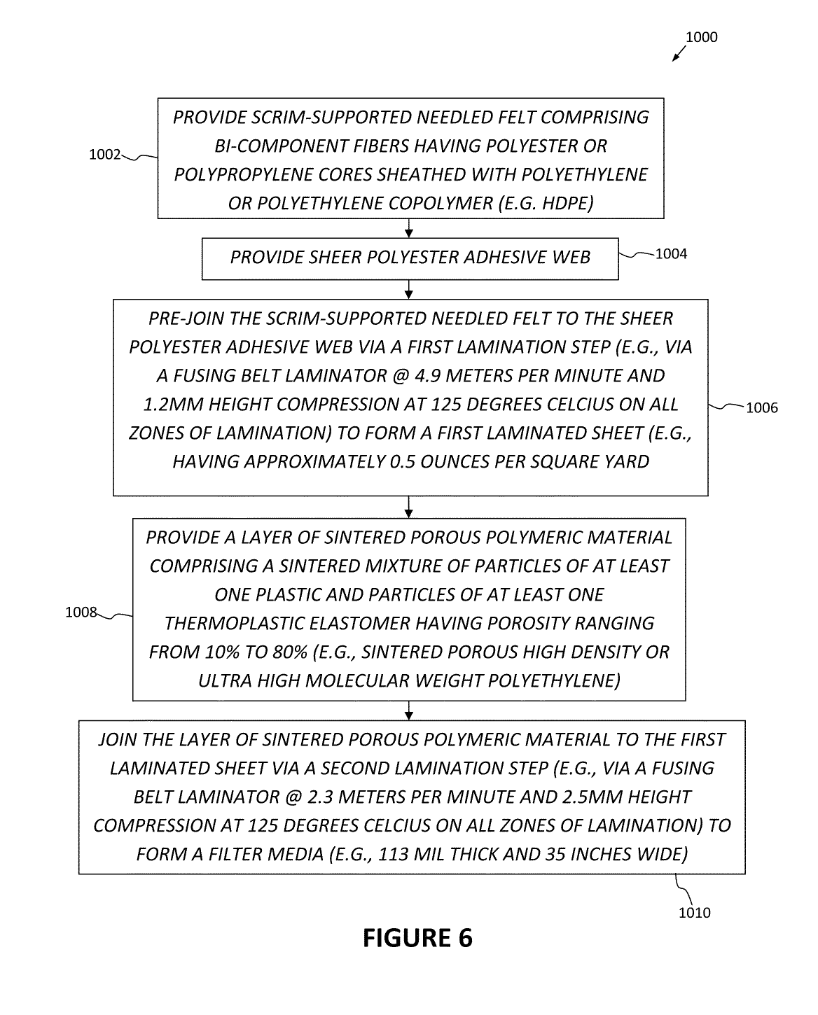

Turning to FIG. 6, an embodiment for a method 1000 of manufacturing filter media is shown. The exemplary method 1000 comprises the steps of: providing a non-woven fibrous material 1002, providing a web of bonding material 1004, pre-attaching 1006 the web to the non-woven fibrous material to form a first laminate, providing 1008 a sheet of sintered porous material, and laminating 1010 the sintered porous material to the first laminate, without limitation. Additional steps and/or variations of the aforementioned steps are anticipated.

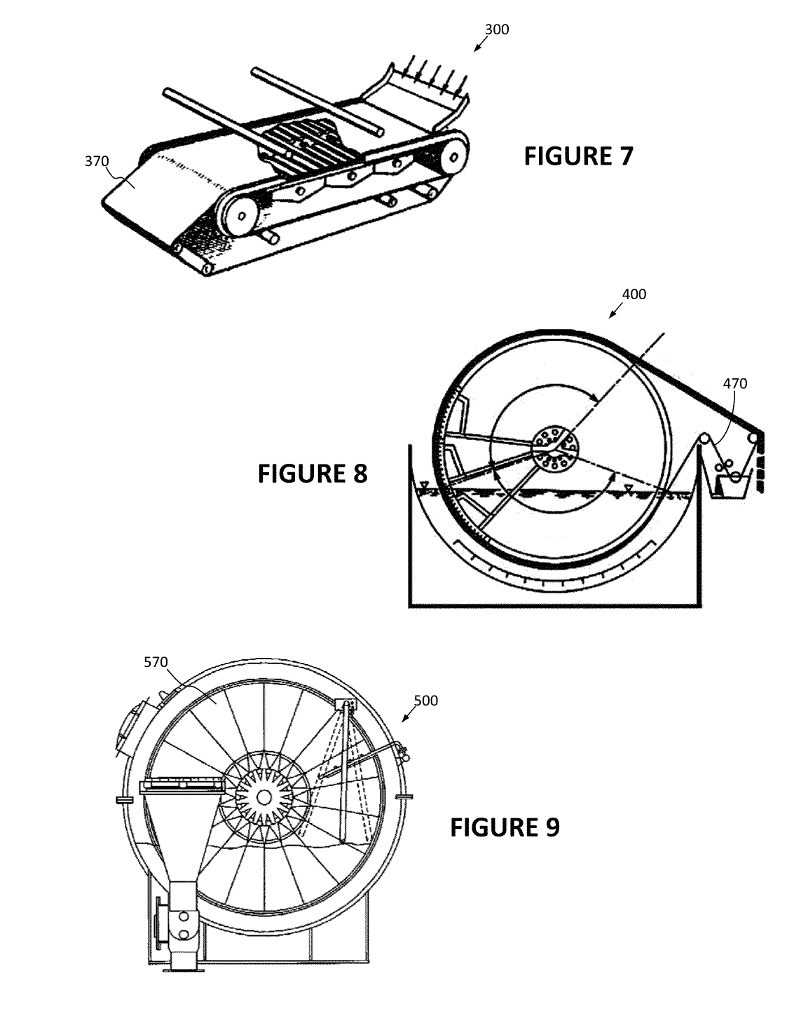

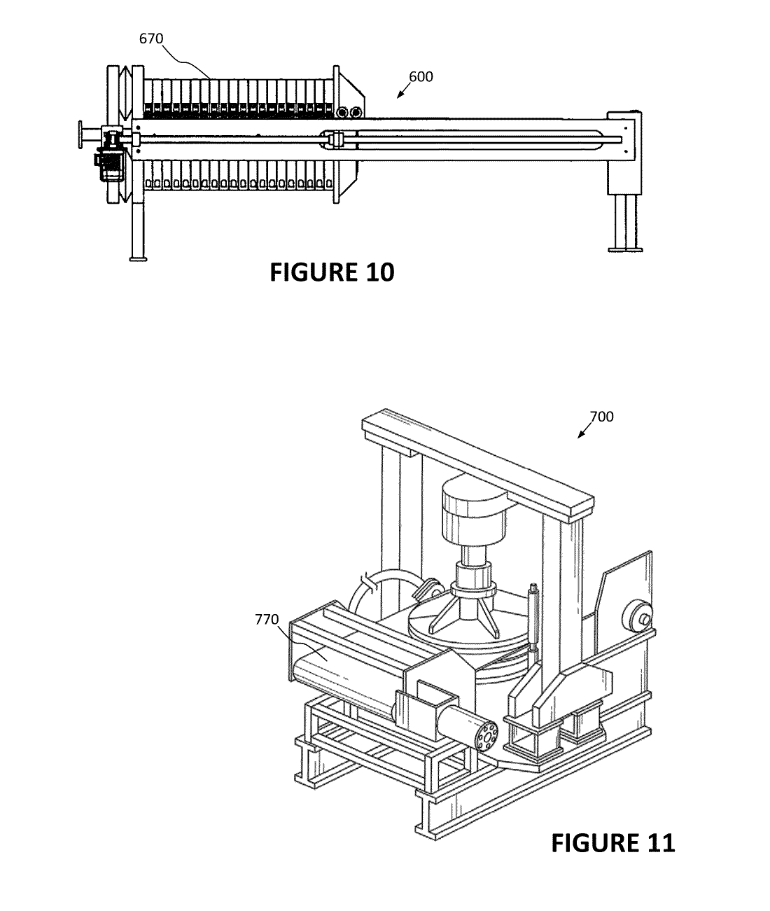

FIGS. 7-11 depict a few machines on which filter media disclosed herein may be advantageously utilized. It should be understood that filter media disclosed herein may also be utilized on devices which are not shown, and that the filtering devices described herein are non-exhaustive applications of the filter media disclosed herein. FIG. 7 is a perspective view of a vacuum belt filter 300 incorporating filter media 370 according to the invention, wherein filter media 30 may be provided in the form of a belt which is configured to pass over a series of vacuum pan trays. FIG. 8 is a cutaway view of a drum filter 400 incorporating filter media 470. FIG. 9 is cutaway view of a disk filter 500 incorporating filter media 570 according to some embodiments, wherein the filter media 570 may be provided in large circular or pie-shaped segments. FIG. 10 is side plan view of a “plate-and-frame”-type filter press 600 incorporating filter media 670 according to the invention. The filter media 670 may be provided with a central slurry feed-pipe aperture, and an outer perimeter of the filter media 670 may comprise a square or generally rectangular shape. FIG. 11 is a perspective view of a PNEUMAPRESS® automatic pressure filter 770 incorporating filter media 770 according to the invention. The filter media 770 for an automatic pressure filter 770 may be provided as a plurality of smaller individual belts for individual filtration modules (e.g., PNEUMAPRESS® stacked filters). Alternatively, the filter media 770 for an automatic pressure filter 770 may be provided as a single large belt having a configuration adapted for use with serpentine-type pressure filter machines (not shown).

FIGS. 12-16 show cross-sections of various multi-component fibers which may be utilized in a nonwoven fibrous material 10 when practicing embodiments of the invention. FIG. 12 shows an instance where a bi-component fiber 800 comprises a first component having a first composition, and a second component having a second composition, wherein the first and second components are joined at one e adjacent side portions. The first composition may comprise a first polymer 802, and the second composition of the second component may comprise a second polymer 804. The first 802 and second 804 polymers may be of similar or different materials. FIG. 13 shows an instance where a bi-component fiber 810 comprises a first component having a first composition, and a second component having a second composition wherein the first and second components are joined concentrically. For example, the first component may comprise a core, and the second component may comprise a sheath. The first composition of the core may comprise a first polymer 812, and the second composition of the sheath may comprise a second polymer 814. The first 812 and second 814 polymers may be of similar or different materials. FIG. 14 shows an instance w here a tri-component fiber 820 comprises a first component having a first composition, a second component having a second composition, and a third component having a third composition, wherein the second and third components are woven around the first component. The first component may comprise a core, and the second and third components may comprise portions of a woven sheath. The first composition may comprise a first polymer 822, the second composition may comprise a second polymer 824, and the third composition may comprise a third polymer 826. The first 822, second 824, and/or third 826 polymers may be of similar or different materials in various configurations. FIG. 15 shows an instance where a tri-component fiber 830 comprises a first component having a first composition, a second component having a second composition, and a third component having a third composition, wherein the second and third components jointly form a sheath around the first component. The first component may comprise a core, and the second and third components may comprise clamshell portions of a sheath in any ratio (i.e., a ratio of 1:1 is shown). The first composition may comprise a first polymer 832, the second composition may comprise a second polymer 834, and the third composition may comprise a third polymer 836. The first 832, second 834, and/or third 836 polymers may be similar or different from each other in any configuration. FIG. 16 shows an instance where a tri-component fiber 840 comprises a first component having a first composition, a second component having a second composition, and a third component having a third composition, wherein the first, second, and third components are layered in side-by-side fashion (similar to what is shown and described in FIG. 1). The first component may comprise a core, and the second and third components may sandwich portions of the first component. The first composition may comprise a first polymer 842, the second composition may comprise a second polymer 844, and the third composition may comprise a third polymer 846. The first 842, second 844, and/or third 846 polymers may be similar or different from each other in any configuration.

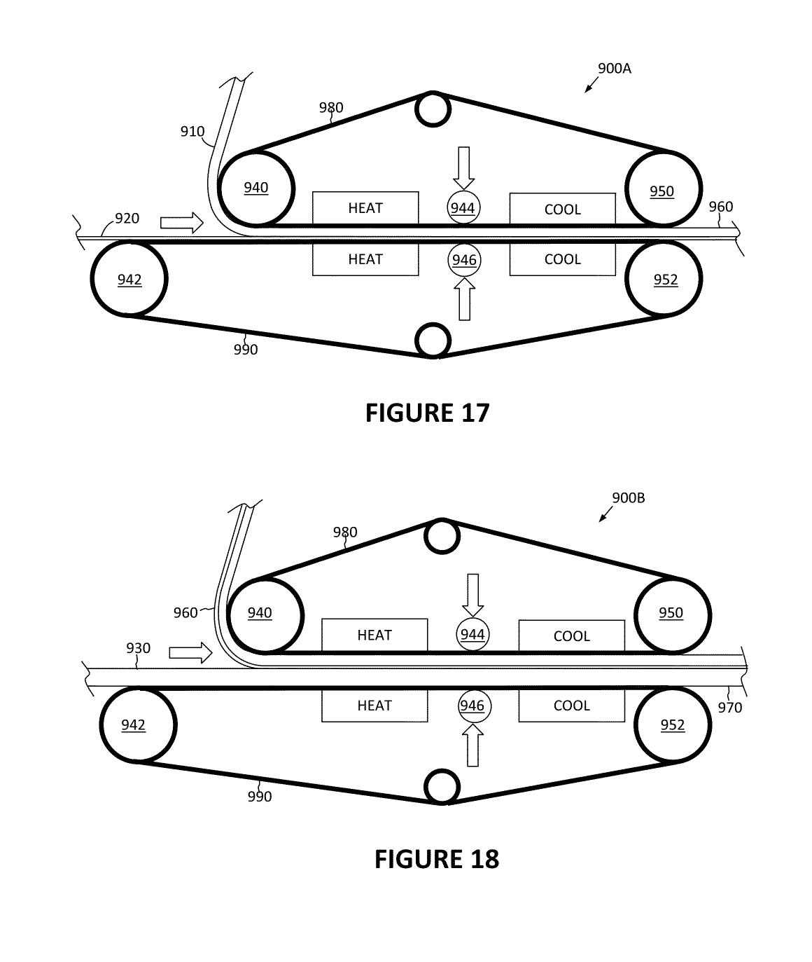

FIGS. 17 and 18 are schematic illustrations which collectively show a third method 900 of manufacturing filter media 970 using a fusing belt laminator according to some embodiments. The third method 900 may comprise a first step 900A and a second step 900B. The first step 900A may comprise joining a nonwoven fibrous material 910 with a web of bonding material 920 with a fusing belt laminator. As the nonwoven fibrous material 910 and web of bonding material 920 are heated and then pressed between an upper belt 980 and a lower belt 990, they are mechanically joined. The resulting composite first laminate 960 may be cooled while still under pressure between the upper 980 and lower 990 belts as shown. Upper 980 and lower 990 belts may be supported by upper 940 and lower 942 first rollers; upper 950 and lower 952 second rollers; and upper 944 and lower 946 third rollers and may be spaced to create equally uniform or progressive height of compression gap spacings between belts 980, 990. After the first step 900A is completed, the first laminate 960 may be joined with a layer of sintered porous material 930 in a second step 900B. The second step 900B may comprise laminating the first laminate 960 with a layer of sintered porous material 930, wherein the web of bonding material 920 of the first laminate 960 is most adjacent to the layer of sintered porous material 930. The resulting laminate may comprise a final or intermediate filter media 970 product.

Testing was conducted on one embodiment of the filter media. The testing showed that embodiments of the filter media disclosed herein outperformed conventional woven filter media and, although it was manufacturable at slightly higher costs, it significantly improved the cost benefit over time for the customer and overall value proposition. As another example, embodiments of my filter media were found to have substantially better chemical resistance and would be more suitable for food grade use than other conventional filter media. Further embodiments of my filter media permitted improved resistance to sheer and delamination, as well as better permeability, substantially improved heat resistance, and resistance to wear from abrasive solids when compared with other conventional woven filter media.

Further, a higher throughput and higher solids capture resulted from use of embodiments of my filter media as compared to conventional filter media. For instance, liquid clear times were much improved as compared to conventional filter media. Additionally, titanium dioxide, magnesium hydroxide, and starch solids were captured at much higher rates when an embodiment of my filter media was used as compared to when a conventional filter media was used in the filtration of a slurry. It was further discovered that a big advantage of my filter media is that it exhibits much improved filtration for certain processes. For example, a test sample exhibited filtration rates of up to 5 cubic feet per minute (CFM) in various challenging filtration industries (e.g., titanium dioxide, magnesium hydroxide, municipal wastewater, and starch processes), whereas conventional woven filter media was only able to achieve between 0.25 and 0.5 CFM. This large increase in dewatering rate substantially reduces the need for capital filtration equipment and large footprint operations, reduces power consumption, and minimizes the chance of missing production quotas. Moreover, it was discovered that a release of the filtered solids was also improved by use of an embodiment of my filter media and required substantially less scraping or washing of the filter media to release the solids captured therein.

Below is one example of a filter media that was formed during testing. It should be understood that the below example merely provides one particular exemplary embodiment of a filter media that may be formed using exemplary teachings the present invention. It is anticipated that other filter media and methods of forming said filter media may be utilized according to the disclosure as a whole.

### EXAMPLE

Scrim-supported non-woven needled polypropylene felt comprised of bi-component concentric sheath fibers was provided. The bi-component fibers comprised approximately a 1:4 ratio of total fibers in the felt, and included high-density polyethylene (HDPE) sheathing to polypropylene core. The needled felt was provided in a plain finish in a width measuring approximately 35 inches, trimmed from a stock 70-inch width (e.g., Southern Felt product number PP-13.5/TT-UP).

A thin web of single or multi-ply polyolefin adhesive film was also provided. The web appeared to be roughly half as thick as a fabric softener sheet. The thin web used was Spunfab® brand polyolefin fiber (product number POF4002) weighing approximately 0.50 ounces per square yard of material (Spunfab® is a registered trademark of Keuchel Assoc., Inc.).

The thin web of polyolefin adhesive film was combined with the of bi-component HDPE/PP needled felt in a fusing belt laminator at an approximate 4.9 meters per minute feed rate, approximate 1.2 mm height compression gap setting, and approximate 125 degree Celsius temperature on all zones of lamination. The combined thin adhesive web and needled felt formed a first laminate which measured about the same thickness as the bi-component HDPE/PP needled felt and weighed only slightly more than the bi-component HDPE/PP needled felt.

Sintered porous material was further provided in the way of a micro-porous sheet of non-compactable crystalline high-density polyethylene HDPE (e.g., POREX® brand Style EPN-01523). The micro-porous sheet was provided in a width of approximately 28.75 inches. The micro-porous sheet had an average pore size between approximately 10 and 20 micrometers and was suitable for continuous service use at temperatures up to 180° F. (82° C.) and intermittent service use at 240° F. (116° C.)—when not stressed. The micro-porous sheet formed a strong, lightweight, tough outer layer for filter media which is resistant to concentrated acids, alkalis, and many organic solvents.

The micro-porous sheet and the first laminate of needled felt and web of bonding material were fused together using a wide fusing belt laminator at a rate of approximately 2.3 meters per minute feed rate at a height compression gap of approximately 2.3 mm and a temperature of approximately 125 degrees Celsius maintained on all zones of lamination. The finished product comprised an approximately 113 mil thick filter media product which was robust to large heavy-duty filtration environments, less susceptible to blinding and abrasion, and less prone to delaminating even at sharp corners/bends, tortuous mounting features, and fatiguing localized changes in local belt tension.

It should be appreciated that a contractor or other entity may provide a filter media, manufacturing apparatus for making filter media, or operate a manufacturing apparatus in whole, or in part, as shown and described. For instance, the contractor may receive a bid request for a project related to designing filter media or operating an apparatus for making filter media, or the contractor may offer to design such a filter media system or a process for a client. The contractor may then provide, for example, any one or more of the devices or features thereof shown and/or described in the embodiments discussed above. The contractor may provide such devices by selling those devices or by offering to sell those devices. The contractor may provide various embodiments that are sized, shaped, and/or otherwise configured to meet the design criteria of a particular client or customer. The contractor may select various materials which are able to meet the design criteria of a particular client or customer. The contractor may subcontract the fabrication, delivery, sale, or installation of a component of the devices disclosed, or of other devices used to provide or manufacture said devices. The contractor may also survey a site and design or designate one or more storage areas for stacking the material used to manufacture the devices, or for storing the devices and/or components thereof. The contractor may also maintain, modify, or upgrade the provided devices. The contractor may provide such maintenance or modifications by subcontracting such services or by directly providing those services or components needed for said maintenance or modifications, and in some cases, the contractor may modify a preexisting pressure filter or other manufacturing apparatus, or parts thereof with a “retrofit kit” to arrive at a modified apparatus comprising one or more method steps, devices, components, or features of the systems and processes discussed herein.

Although the invention has been described in terms of particular embodiments and applications, one of ordinary skill in the art, in light of this teaching, can generate additional embodiments and modifications without departing from the spirit of or exceeding the scope of the claimed invention.

For example, in some embodiments, self-supported bi-component needled felt (which does not comprise scrim) may also be utilized. Moreover, while certain embodiments of the invention incorporate a layer of sintered porous material having a mean pore size which is generally between 10 and 20 micrometers, it may be possible to have nominal pore size values ranging between 5 and 150 micrometers, and even up to 300 micrometers, depending on which materials are used. In some embodiments, the nonwoven fibrous material may comprise blends of polyester fiber and bi-component polyethylene-sheathed polyester, wherein the sintered porous material comprises ultra-high molecular weight polyethylene (UHMWPE). In some embodiments, the nonwoven fibrous material may alternatively comprise blends of polyester fiber and bi-component polyethylene-sheathed polypropylene fiber. In some embodiments, the nonwoven fibrous material may comprise blends of polyester fiber, bi-component polyethylene-sheathed polypropylene fiber, and bi-component polyethylene-sheathed polypropylene fiber. Porous sintered material disclosed herein may comprise one or more types of polyethylene, including low density-types (LDPE), high density types (HDPE), and ultra-high molecular weight types (UHMWPE).

Bi-component fibers discussed herein may comprise a polypropylene core and high-density polyethylene sheath. In some embodiments, the bi-component fibers may comprise a polyethylene terephthalate copolymer (CoPET) sheath and polyethylene terephthalate homopolymer (PET) core. In some embodiments, the bi-component fibers may comprise an high density polyethylene (HDPE) sheath and PET core. In some embodiments, an HDPE sheath and polypropylene (PP) core may be utilized. In some embodiments, a polyphenylene sulfide (PPS) sheath and PET core may be utilized. In some embodiments, the bi-component fibers may comprise a PET sheath and polylactide/thermoplastic aliphatic polyester (PLA) core. In some embodiments, a PET sheath and a polyamide (e.g., PA 6) core may be utilized. Single monofilament fibers comprising PET, PPS, PA, PE, or PE may be provided within the nonwoven fibrous material alone or in combination with bi-component fibers. Nonwoven fibrous material 10 may comprise fibers having a composition comprising polyamide P84®, NOMEX® polymer manufactured by DuPont, brown polytetrafluoroetylene (PTFE), or white polytetrafluoroetylene (PTFE), without limitation.

While certain present preferred embodiments of a filtration media, an apparatus for making filtration media and methods of making and using the same have been shown and described above, it is to be distinctly understood that the invention is not limited thereto but may be otherwise variously embodied and practiced within the scope of the following claims.

### REFERENCE NUMERAL IDENTIFIERS

1 first method
10 nonwoven fibrous material
20 web of bonding material
30 sintered porous material
40 upper first roller
42 lower first roller
50 upper second roller
52 lower second roller
60 first laminate
70 filter media
100 second method
100A first step
100B second step
110 nonwoven fibrous material
120 web of bonding material
130 sintered porous material
140 upper first roller
142 lower first roller
150 upper second roller
152 lower second roller
160 first laminate
170 filter media
210 nonwoven fibrous material
212 sheath
214 void
216 core
220 web of bonding material
226 strand
230 sintered porous material
232 fenestration
234 pore
300 vacuum belt filter
370 filter media
400 vacuum drum filter
470 filter media
500 vacuum disk filter
570 filter media
600 filter press
670 filter media
700 automatic pressure filter
770 filter media
800 bi-component fiber
802 first polymer
804 second polymer
810 bi-component fiber
812 first polymer
814 second polymer
820 tri-component fiber
822 first polymer
824 second polymer
826 third polymer
830 tri-component fiber
832 first polymer
834 second polymer
836 third polymer
840 tri-component fiber
842 first polymer
844 second polymer
846 third polymer
900 third method
900A first step
900B second step
910 nonwoven fibrous material
920 web of bonding material
930 sintered porous material
940 upper first roller
942 lower first roller
944 upper third roller
946 lower third roller
950 upper second roller
952 lower second roller
960 first laminate
970 filter media
980 upper belt
990 lower belt
1000 third method
1002 first step
1004 second step
1006 third step
1008 fourth step
1010 fifth step

1. A method of making filter media for large industrial filtration devices comprising:
providing a layer of nonwoven fibrous material;
providing a web of bonding material;
providing a layer of sintered porous material;
joining the layer of nonwoven fibrous material with the web of bonding material; and
joining the layer of sintered porous material to the web of bonding material.

2. The method of claim 1, wherein the step of joining the layer of nonwoven fibrous material with the web of bonding material comprises a laminating step to form a first laminate.

3. The method of claim 2, wherein the step of joining the layer of sintered porous material to the web of bonding material comprises laminating the first laminate with the layer of sintered porous material.

4. The method of claim 1, wherein the step of joining the layer of sintered porous material to the web of bonding material occurs after the step of joining the layer of nonwoven fibrous material with the web of bonding material.

5. The method of claim 1, wherein the layer of sintered porous material comprises at least one polymer.

6. The method of claim 5, wherein the at least one polymer comprises at least one of: polyethylene, polypropylene, polyester, polycarbonate, polyvinylidene fluoride, polytetrafluoroethylene, polyvinylidene fluoride, ethyl vinyl acetate, polycarbonate, polycarbonate alloy, nylon 6, thermoplastic polyurethane (TPU), polyethersulfone (PES), and polyethylene-polypropylene copolymer.

7. The method of claim 6, wherein the at least one polymer comprises high-density polyethylene (HDPE) or ultra-high molecular weight polyethylene (UHMWPE).

8. The method of claim 5, wherein the layer of sintered porous material comprises particles of a first polymer and particles of a second polymer;
wherein said first polymer selected from the group consisting of: polyethylene, polypropylene, polyesters, polycarbonates, polyvinylidene fluoride, polytetrafluoroethylene, polyethersulfones, polystyrenes, polyether imides, polyetheretherketones, polysulfones, and combinations thereof; and,
wherein said second polymer comprises a thermoplastic elastomer ted from the group consisting of: thermoplastic polyurethanes, polyisobutylene, polybutenes, polyethylene-propylene copolymer, polyethylene-butene copolymer, polyethylene-octene copolymer, polyethylene-hexene copolymer, chlorinated polyethylene, chloro-sulfonated polyethylene, styrene-ethylene-butadiene-styrene, multiblock copolymers having a polyurethane and either a polyester or polyether, 1,3-dienes, and combinations thereof.

9. The method of claim 1, wherein the layer of sintered porous material comprises a reticulated structure having a mean porosity between approximately 20 and 80%.

10. The method of claim 1, wherein the layer of sintered porous material comprises a rigidity according to ASTM D747 of less than about 15 pounds

11. The method of claim 1, wherein the nonwoven fibrous material comprises unsupported or scrim-supported needled felt.

12. The method of claim 1, wherein the nonwoven fibrous material comprises bi-component fibers having a core and sheath of different polymeric materials.

13. The method of claim 12, wherein said bi-component polymeric fibers comprise a polypropylene core and a high density polyethylene sheath.

14. The method of claim 1, wherein the nonwoven fibrous material comprises multi-component fibers, wherein the multi-component fibers comprise at least two different polymeric materials selected from the group consisting of: polyethylene (PE), high density polyethylene (HDPE), ultra-high molecular weight polyethylene (UHMWPE), linear low density polyethylene (LLDPE), glycol-modified PET (PETG), polypropylene (PP), polylactic acid (PLA), polyphenylene sulfide (PPS), polyethylene terephthalate (polyester/PET), copolyester (CoPET), and combinations thereof.

15. The method of claim 14, wherein the multi-component polymeric fibers are tri-component fibers.

16. The method of claim 1, wherein the web of bonding material comprises a polymer.

17. The method of claim 16, wherein the polymer comprises a polyamide, polyester, an elastomeric, a urethane, an olefin polymer, or a composite thereof.

18. The method of claim 17, wherein the polymer comprises a sheer polyolefin sheet.

19. The method of claim 1, wherein the step of joining the nonwoven fibrous material with the web of bonding material is performed using a fusing belt laminator.

20. The method of claim 19, wherein the step of joining the nonwoven fibrous material with the web of bonding material is performed at a rate between approximately 1 and 10 meters per minute.

21. The method of claim 20, wherein the step of joining the nonwoven fibrous material with the web of bonding material is performed at a rate of approximately 4.5 to 5.5 meters per minute.

22. The method of claim 19, wherein the step of joining the nonwoven fibrous material with the web of bonding material comprises a height compression of between approximately 0.1 and 2.5 mm.

23. The method of claim 22, wherein the step of joining the nonwoven fibrous material with the web of bonding material comprises a height compression of between approximately 0.9 and 1.5 mm.

24. The method of claim 19, wherein the step of joining the nonwoven fibrous material with the web of bonding material is performed at a temperature of between approximately 100 and 150 degrees Celsius.

25. The method of claim 24, wherein the step of joining the nonwoven felt material with the web of bonding material is performed at a temperature of between approximately 120 and 130 degrees Celsius on all zones of lamination.

26. The method of claim 3, wherein the step of laminating the first laminate with the layer of sintered porous material performed using a fusing belt laminator.

27. The method of claim 3, wherein the step of laminating the first laminate with the layer of sintered porous material is performed at a rate between approximately 0.5 and 5 meters per minute.

28. The method of claim 27, wherein the step of laminating the first laminate with the layer of sintered porous material is performed at a rate of approximately 2.0-2.5 meters per minute.

29. The method of claim 3, wherein the step of laminating the first laminate with the layer of sintered porous material comprises a height compression of between approximately 0.1 and 5 mm.

30. The method of claim 29, wherein the step of laminating the first laminate with the layer of sintered porous material comprises a height compression of between approximately 2.2 and 2.8 mm.

31. The method of claim 3, wherein the step of laminating the first laminate with the layer of sintered porous material is performed at a temperature of between approximately 100 and 150 degrees Celsius on zones of lamination.

32. The method of claim 31, wherein the step of laminating the first laminate with the layer of sintered porous material is performed at a temperature of between approximately 120 and 130 degrees Celsius on all zones of lamination.

33. A filter media manufactured by the method of claim 1.

34. A filter media comprising:
a layer of nonwoven fibrous material;
a layer of sintered porous material; and,
a web of bonding material between the layer of nonwoven fibrous material and the layer of sintered porous material;
wherein the nonwoven fibrous material is bonded to the web of bonding material; wherein the layer of sintered porous material is bonded to the web of bonding material; and wherein the filter media is configured to withstand harsh industrial vacuum or pressure filtration environments, resist delamination, and be used on large industrial filtration devices.

35. The filter media of claim 34, wherein the layer of nonwoven fibrous material comprises polymeric felt; wherein the layer of sintered porous material comprises a sintered polymeric particles; and, wherein the web of bonding material comprises a sheer polymeric sheet.

36. The filter media of claim 35, wherein the polymeric particles comprise one or more of the following: polyethylene, polypropylene, polytetrafluoroethylene, polyvinylidene fluoride, ethyl vinyl acetate, polycarbonate, polycarbonate alloy, nylon 6, thermoplastic polyurethane, polyethersulfone, polyethylene-polypropylene copolymer, and composites thereof

37. The filter media of claim 35, wherein the polymeric felt is scrim-supported.

38. The filter media of claim 35, wherein the sintered polymeric particles comprise high-density polyethylene (HDPE) or ultra-high molecular weight polyethylene (UHMWPE).

39. The filter media of claim 35, wherein the polymeric felt comprises bi-component fibers having a core and sheath of different polymeric materials.

40. The filter media of claim 39, wherein the bi-component fibers comprise at least two different polymeric materials selected from the group consisting of: polyethylene (PE), high density polyethylene (HDPE), ultra-high molecular weight polyethylene (UHMWPE), linear low density polyethylene (LLDPE), glycol-modified PET (PETG), polypropylene (PP), polylactic acid (PLA), polyphenylene sulfide (PPS), polyethylene terephthalate (polyester/PET), copolyester (CoPET), and combinations thereof.

41. The filter media of claim 40, wherein the bi-component fibers comprise a polypropylene core and high-density polyethylene sheath.

42. The filter media of claim 35, wherein the sheer polymeric sheet comprises a polyamide, polyester, an elastomeric, a urethane, an olefin polymer, or a composite thereof.

43. The filter media of claim 42, wherein the sheer polymeric sheet comprises a adhesive web of polyolefin fiber that weighs between approximately 0.25 and 0.75 ounces per square yard of material.

44. The filter media of claim 34, wherein the layer of nonwoven fibrous material is between approximately 10 and 150 mils thick;
wherein the layer of sintered porous material is between approximately 0.5 and 25 mils thick; and, wherein the web of bonding material is between approximately 0.1 and 10 mils thick.

45. The filter media of claim 34, wherein the overall thickness of the filter media is between approximately 75 and 150 mils thick.

46. The filter media of claim 45, wherein the overall thickness of the filter media is between approximately 95 and 130 mils thick.

47. The filter media of claim 46, wherein the overall thickness of the filter media is between approximately 105 and 120 mils thick.
